(19) United States
(12) Patent Application Publication
(10) Pub. No.: US 2026/0073067 A1
(43) Pub. Date: Mar. 12, 2026

(54) SYSTEM AND METHOD FOR PREVENTING DATA LEAKAGE BY REALTIME NATIVE FINGERPRINTING INSIDE A CLOUD STORAGE

(71) Applicant: Vikalp Shrivastava, Gwalior (IN)

(72) Inventor: Vikalp Shrivastava, Gwalior (IN)

(21) Appl. No.: 19/045,408

(22) Filed: Feb. 4, 2025

Related U.S. Application Data
(60) Provisional application No. 63/693,636, filed on Sep. 11, 2024.

(51) Int. Cl. G06F 21/62

(52) U.S. Cl. CPC G06F 21/6218

(57) ABSTRACT

The present disclosure provides a system and a method for performing real-time cloud-native fingerprinting and managing sensitive content within a cloud storage platform to prevent data leakage. The system comprises a cloud storage platform comprising a data leakage prevention (DLP) server. The DLP server configured for receiving and storing a sensitive document, receiving a sensitivity level of the sensitive document, fingerprinting the sensitive document based on the sensitivity level, indexing and storing the fingerprint, sharing the fingerprint to an endpoint security agent, receiving leak indication, performing leak analysis and notifying the leak to a document owner. The system and method further perform monitoring of the sensitive data that has been fingerprinted and stored under a security folder, for a predefined time and automatically moving the sensitive data from the security folder after the predefined time.

### BACKGROUND

### Technical Field

The present disclosure generally relates to data management and protection, more particularly, to a system and method for preventing data leakage by real time native fingerprinting of sensitive data, inside a cloud storage without providing access to third party solutions or information technology (IT) personnel. The system and method of the present disclosure further perform monitoring of the sensitive data that has been fingerprinted and stored under a security folder, for a predefined time and automatically moving the sensitive data from the security folder to a non-security folder after the predefined time.

### Description of the Related Art

Data security is a crucial issue for systems handling sensitive content today. Various types of data including, but not limited to, bank account numbers, sensitive business information, confidential government documents, medical records, and national security-related information, require different levels of protection. Cloud-based storage systems are often used to store such sensitive data, and solutions have been developed to safeguard this information. However, such existing solutions often rely on external systems, and protecting documents remains challenging. For instance, when a portion of a document is copied from cloud storage platforms like Microsoft® Office 365 or similar file storage servers, detecting leaks becomes difficult. Currently, data leakage prevention (DLP) solutions can protect entire documents, such as Excel, PowerPoint, and Word files, by using metadata tags. However, these metadata tags are not effective if only a section of a document, such as a row or a paragraph, is copied and transmitted through authorized or unauthorized channels like email or messaging services. Such partial thefts often go undetected because existing systems are not equipped to identify these leaks. Further, GenAI prompts are a big risk for data leak in case some user puts sensitive content sentence on the GenAI prompt as there is no way to detect if that information is classified/confidential or not. It is to be noted that GenAI prompts are the inputs or instructions given to a generative AI model to guide it in producing a desired output. As existing classification either works on the meta tag or based on dictionary matching/pattern matching, which are not effective in blocking the AI prompt. Hence, there is no detection and blocking of AI prompt for confidential and/or sensitive content.

Fingerprinting-based DLP systems exist, but they are not fully integrated within cloud storage systems or platforms. This means that current DLP systems must download the sensitive document out of the cloud-based file storage systems to perform the fingerprinting process which creates more risk to the documents security and confidentiality. Existing fingerprinting systems use Application Programming Interface (API) to connect with the cloud storage platforms to create document fingerprints. Moreover, current systems do not offer a self-managed fingerprinting solution, requiring users to grant information technology (IT) support personnel access to documents for fingerprinting. Such approach could potentially compromise document security, as third parties may gain access to the sensitive content. Additionally, users must rely on the IT personnel for security management and changes in sensitivity status, increasing the risk of unauthorized access by IT administrators or third-party systems without the document owner's knowledge. Some solutions also act as intermediaries, keeping copies of documents before they reach the cloud, further complicating the security landscape. Therefore, the existing data leakage prevention systems are lacking a major security requirement of identifying and protecting sensitive documents based on real time fingerprinting.

Accordingly, there remains a need for a system and method for preventing data leakage in cloud storage environments.

### BRIEF DESCRIPTION OF DRAWINGS

The embodiments herein will be better understood from the following detailed description with reference to the drawings, in which:

FIG. 1 is a block diagram of a system for performing real-time cloud-native finger printing and managing sensitive content within a cloud storage platform to prevent data leakage, according to some embodiments herein;

FIG. 2 is a block diagram that illustrates one or more components of a data processing unit of the cloud storage platform of FIG. 1 according to some embodiments herein;

FIG. 3 is a block diagram that illustrates one or more modules of a data leaking protection server of FIG. 1, according to some embodiments herein;

FIG. 4 is a block diagram that illustrates one or more modules of a first end user device of FIG. 1, according to some embodiments herein;

FIG. 5 is a block diagram that illustrates one or more modules of a security agent of a second end user device of FIG. 1, according to some embodiments herein;

FIG. 6 is a block diagram that illustrates a DLP folder created in the DLP server of FIG. 1, according to some embodiments herein;

FIGS. 7A-7B are an interaction diagram that illustrate a process of real-finger printing of information in a cloud storage platform for preventing data leakage, according to some embodiments herein;

FIGS. 8A-8B are flow diagram that illustrates a method for performing real-time cloud-native fingerprinting and managing sensitive content within a cloud storage platform to prevent data leakage, according to some embodiments herein; and

FIG. 9 is a schematic diagram of a computer architecture in accordance with the embodiments herein.

### SUMMARY OF THE INVENTION

The first aspect of the present invention provides a system for performing real-time cloud-native fingerprinting and managing sensitive content within a cloud storage platform to prevent data leakage is provided. The system includes one or more first-end user devices associated with first users, and one or more second end user devices installed with an endpoint security agent. The one or more first end user devices and the one or more second end user devices are communicatively coupled to the cloud storage platform via a network. The data leakage protection (DLP) server within the cloud storage platform includes a memory unit for storing a first set of instructions and a processor configured to execute the first set of instructions to perform various functions of the DLP server that includes, (i) receiving documents uploaded through the one or more first end user devices; (ii) performing cloud-native fingerprinting of sensitive content of the documents directly within the cloud environment utilizing native cloud resources without transferring the documents out of their native cloud, the sensitive content is analyzed by performing at least one of a content analysis, a fingerprint analysis, a metadata examination, and a policy evaluation using a machine learning model, (iii) performing granular or less-granular fingerprinting of the sensitive content based on a sensitivity level of the document in real-time, the granular finger printing of the sensitive content is performed by generating a unique digital identifier for each individual data unit in the sensitive content, when the sensitivity level is 90% or above, the less-granular fingerprinting is performed by generating the unique digital identifier for segments of data in the sensitive content, when the sensitivity level is 50% or below, the fingerprinted sensitive content is stored in a designated DLP folder; (iv) detecting the data leakage by continuously comparing local files in the one or more second end user devices with the fingerprinted sensitive content and notifying the DLP server; and (v) analyzing any identified leaked fingerprint to determine the source document, specific leaked data, and/or leaking endpoint location.

In some embodiments, the machine learning model is configured to perform (i) the content analysis using predefined keywords, phrases, or patterns indicative of the sensitive content, (ii) the fingerprint analysis by comparing the document's fingerprint with previously stored fingerprints in a fingerprint index table, the fingerprint index table comprises indices and catalogs of the created fingerprints, (iii) the metadata examination by analyzing the metadata associated with the document, comprising author, creation date, access permissions, and classification labels, and (iv) the policy evaluation by comparing the document's content and metadata against predefined security policies comprising storage location and protection requirements based on document classification and sensitivity.

In some embodiments, the DLP server is further configured to (i) prompt the one or more first end user devices to set a sensitivity level for the document and (ii) receive the sensitivity level from the one or more first end user devices.

In some embodiments, the DLP server is further configured to automatically block copying or sharing of the sensitive document if a match is found during the comparison of local files on the one or more second end user devices with the received fingerprinted sensitive content.

In some embodiments, the DLP server is further configured to map the DLP folder to a main folder of the first end user device's cloud storage account.

In some embodiments, the DLP server is further configured to (i) monitor the sensitive content of the documents for a predefined time, after which the document is moved to a non-security storage server, and (ii) update the fingerprint index table and security endpoint lists.

In some embodiments, the DLP server is further configured to continuously monitor access to the DLP folder, log access events, and notify the first user of any unusual access attempts or policy violations in real-time.

In some embodiments, the DLP server is further configured to create an account on the cloud storage platform for the first users by receiving a registration request from the one or more first end user devices, enabling the uploading of the documents.

The second aspect of the present invention provides a method for performing real-time cloud-native fingerprinting and managing sensitive content within a cloud storage platform to prevent data leakage. The method includes, (i) providing one or more first end user devices associated with first users; (ii) providing one or more second end user devices installed with an endpoint security agent, the one or more first end user devices and the one or more second end user devices are communicatively coupled to the cloud storage platform via a network; (iii) receiving documents uploaded through the one or more first end user devices by a data leakage protection (DLP) server within the cloud storage platform; (iv) performing cloud-native fingerprinting of sensitive content of the documents directly within the cloud environment utilizing native cloud resources without transferring the documents out of their native cloud, the sensitive content is analyzed by performing at least one of a content analysis, a fingerprint analysis, a metadata examination, and a policy evaluation using a machine learning model, (v) performing granular or less-granular fingerprinting of the sensitive content based on a sensitivity level of the document in real-time, the granular finger printing of the sensitive content is performed by generating a unique digital identifier for each individual data unit in the sensitive content, when the sensitivity level is 90% or above, the less-granular fingerprinting is performed by generating the unique digital identifier for segments of data in the sensitive content, when the sensitivity level is 50% or below, the fingerprinted sensitive content is stored in a designated DLP folder; (vi) detecting the data leakage by continuously comparing local files in the one or more second end user devices with the fingerprinted sensitive content and notifying the DLP server; and (vii) analyzing any identified leaked fingerprint to determine the source document, specific leaked data, and/or leaking endpoint location.

In some embodiments, the machine learning model is configured to perform (i) the content analysis using predefined keywords, phrases, or patterns indicative of the sensitive content, (ii) the fingerprint analysis by comparing the document's fingerprint with previously stored fingerprints in a fingerprint index table, the fingerprint index table comprises indices and catalogs of the created fingerprints, (iii) the metadata examination by analyzing the metadata associated with the document, comprising author, creation date, access permissions, and classification labels, and (iv) the policy evaluation by comparing the document's content and metadata against predefined security policies comprising storage location and protection requirements based on document classification and sensitivity.

In some embodiments, the method further comprises (i) prompting the one or more first end user devices to set a sensitivity level for the document and (ii) receiving the sensitivity level from the one or more first end user devices.

In some embodiments, the method further comprises automatically block copying or sharing of the sensitive document if a match is found during the comparison of local files on the one or more second end user devices with the received fingerprinted sensitive content.

In some embodiments, the method further comprises mapping the DLP folder to a main folder of the first end user device's cloud storage account.

In some embodiments, the method further comprises (i) monitoring the sensitive content of the documents for a predefined time, after which the document is moved to a non-security storage server, and (ii) updating the fingerprint index table and security endpoint lists.

In some embodiments, the method further comprises continuously monitoring access to the DLP folder, log access events, and notify the first user of any unusual access attempts or policy violations in real-time.

In some embodiments, the method further comprises creating an account on the cloud storage platform for the first users by receiving a registration request from the one or more first end user devices, enabling the uploading of documents.

The third aspect of the present invention provides one or more non-transitory computer readable storage mediums storing instructions, which when executed by a processor, causes to perform a method for performing real-time cloud-native fingerprinting and managing sensitive content within a cloud storage platform to prevent data leakage, the method performs the steps of: (i) providing one or more first end user devices associated with first users; (ii) providing one or more second end user devices installed with an endpoint security agent, the one or more first end user devices and the one or more second end user devices are communicatively coupled to the cloud storage platform via a network; (iii) receiving documents uploaded through the one or more first end user devices by a data leakage protection (DLP) server within the cloud storage platform; (iv) performing cloud-native fingerprinting of sensitive content of the documents directly within the cloud environment utilizing native cloud resources without transferring the documents out of their native cloud, the sensitive content is analyzed by performing at least one of a content analysis, a fingerprint analysis, a metadata examination, and a policy evaluation using a machine learning model, (v) performing granular or less-granular fingerprinting of the sensitive content based on a sensitivity level of the document in real-time, the granular finger printing of the sensitive content is performed by generating a unique digital identifier for each individual data unit in the sensitive content, when the sensitivity level is 90% or above, the less-granular fingerprinting is performed by generating the unique digital identifier for segments of data in the sensitive content, when the sensitivity level is 50% or below, the fingerprinted sensitive content is stored in a designated DLP folder; (vi) detecting the data leakage by continuously comparing local files in the one or more second end user devices with the fingerprinted sensitive content and notifying the DLP server; and (vii) analyzing any identified leaked fingerprint to determine the source document, specific leaked data, and/or leaking endpoint location.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

As mentioned, there remains need for a system and method for preventing data leakage in cloud storage environments. The present disclosure provides a system and a method for preventing data leakage by real time native fingerprinting of sensitive data, inside a cloud storage without providing access to third party solutions or information technology (IT) personnel. By utilizing real-time native fingerprinting, the system ensures that sensitive data is protected directly within the cloud storage environment. This reduces a risk of unauthorized access or data breaches that might occur when data is transferred to external systems for processing. The system operates without a need for third-party solutions, minimizing potential vulnerabilities introduced by external providers. This reduces the risk of data exposure or mishandling by outside entities. By not requiring access from information technology (IT) personnel, the system limits a number of individuals who have access to the sensitive data, decreasing the risk of internal data leaks or mishandling. This also streamlines the data protection process, allowing for more efficient operations. Further, the system provides real-time fingerprinting, which allows for immediate detection and protection against data leakage. This ensures that any unauthorized access or copying of data is quickly identified and addressed. According to the present disclosure, quick and real-time document leakage detection and protection will be implemented across all channels, including, but not limited to, mobile devices, personal computers (PCs), laptops, and tablets. This protection mechanism will rely on information fingerprinting instead of focusing on specific messaging channels like email, WhatsApp™, Microsoft Teams™, or SharePoint™. The present disclosure offers a more granular method of protecting information without hindering user or business productivity.

The system and method further perform monitoring of sensitive data that has been fingerprinted and stored under a security folder, for a predefined time and automatically moving the sensitive data from the security folder to a non-security folder after the predefined time. Thus, the system provides an automated approach for managing the lifecycle of the sensitive data. By moving data from security folders to non-security folders after a predefined period, the system ensures that data is only treated as sensitive when necessary, aligning with data retention policies. Typically, security resources such as encryption, access controls, and monitoring tools are more resource-intensive. By automatically transferring data to a non-security folder after its sensitivity period has expired, the system optimizes the use of these resources, freeing them up for other sensitive data. By ensuring that only current sensitive data is stored in the security folders, the system minimizes the risk of unnecessary exposure to the sensitive data. This reduces the attack surface and potential vulnerabilities that could lead to data breaches. Further, automating the movement of data between the security and non-security folders reduces the manual intervention needed to manage data, freeing IT and data management personnel to focus on more critical tasks and reducing the likelihood of human error. The approach of the present disclosure allows the security measures applied to data to be dynamic and responsive to changes in data sensitivity over time. It enables the system to adapt to changing data protection needs without requiring manual updates or policy changes. Furthermore, by moving data to the non-security folders after the predefined period, the system can increase data accessibility for users who need to work with it without the added layers of security, improving productivity while maintaining security controls when necessary.

Furthermore, the present disclosure, the present disclosure if there is a detection on the set of information of a specific data towards AI interface as prompt, the present disclosure will not only alert the user/administrator/data owner but also will be able to hold or block the information leakage to the OpenAI cloud, which if happens cannot be reverted because those clouds are public clouds.

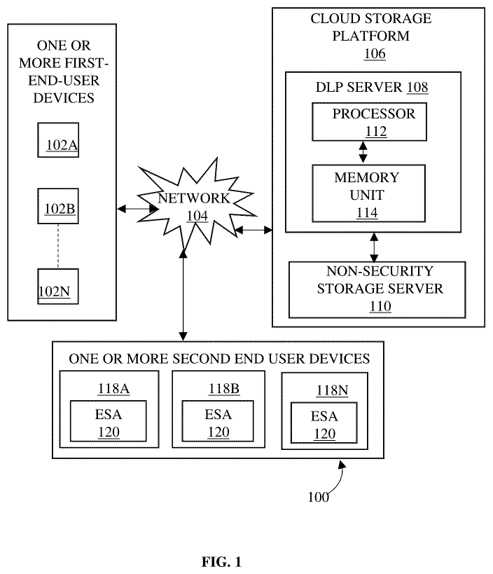

FIG. 1 is a block diagram of a system 100 for performing real-time cloud-native finger printing and managing sensitive content within a cloud storage platform to prevent data leakage according to some embodiments herein. The system 100 includes one or more first end user devices 102A-N, a cloud storage platform 106, and one or more second end user devices 118A-N. The cloud storage platform 106 includes multiple servers for managing, storing, and protecting information. The cloud storage platform 106 includes a data leakage protection (DLP) server 108 and a non-security storage server 110. In some embodiments, the cloud storage platform 106 include one or more DLP servers and one or more non-security storage servers to accommodate varying workloads and scalability requirements.

The DLP server 108 receives documents uploaded through the one or more first end user devices. The DLP server 108 performs cloud-native fingerprinting of sensitive content of the documents directly within the cloud environment utilizing native cloud resources without transferring the documents out of their native cloud. The sensitive content is analyzed by performing at least one of a content analysis, a fingerprint analysis, a metadata examination, and a policy evaluation using a machine learning model. The DLP server 108 performs granular or less-granular fingerprinting of the sensitive content based on a sensitivity level of the document in real-time. The granular finger printing of the sensitive content is performed by generating a unique digital identifier for each individual data unit in the sensitive content, when the sensitivity level is 90% or above. The less-granular fingerprinting is performed by generating the unique digital identifier for segments of data in the sensitive content, when the sensitivity level is 50% or below. The fingerprinted sensitive content is stored in a designated DLP folder. The DLP server 108 detects the data leakage by continuously comparing local files in the one or more second end user devices with the fingerprinted sensitive content and analyzes any identified leaked fingerprint to determine the source document, specific leaked data, and/or leaking endpoint location.

The DLP server 108 is configured for performing real-time fingerprinting of the sensitive content. The sensitive content may refer to data that must be protected due to its confidential nature and potential impact if disclosed to unauthorized individuals. The sensitive content includes, but not limited to, personal identifiable information, financial information, medical information, proprietary business information, intellectual property, legal information, and national security information. The personal identifiable information includes, but not limited to, driver's license numbers, passport numbers, personal addresses, phone numbers, and social security numbers. The financial information, includes, but not limited to, bank account details, credit card numbers, financial statements, tax returns, and salary information. The medical information, includes, but not limited to, medical records, health insurance details, genetic information, and any data related to a person's health condition. The proprietary business information, includes, but not limited to, trade secrets, business plans, proprietary formulas, marketing strategies, and customer lists. The intellectual property, includes, but not limited to, patents, copyrights, trademarks, and unpublished research. The legal information, includes, but not limited to, court documents, attorney-client communications, and settlement agreements. The national security information includes, but not limited to, classified government documents, defense strategies, and intelligence data. The non-security storage server 110 computes without power configured for storing data. In the present disclosure, the term data and information are interchangeably used.

The DLP server 108 and the non-security storage server 110 are communicatively coupled to the one or more first end user devices 102A-N via a network 104. The network 104 includes, but not limited to, a local area network (LAN), a wide area network (WAN), a public network, a private network, a proprietary network, a public telephone switched network (PSTN), the Internet, a wireless network, a virtual network, a mobile network, or any combination thereof. In some embodiments, the one or more first end user devices 102A-N and the one or more second end user devices 118A-N are any computing device that can access and store information in the cloud storage platform 106. The one or more first end user devices 102A-N and the one or more second end user devices 118A-N includes, but not limited to, smartphones, tablets, computers, smart watches, internet of things (IOT) devices, connected vehicles, and any other devices capable of interfacing with the cloud storage system to upload, modify, or retrieve data or information. The one or more first end user devices 102A-N and the second end user devices 118A-N may not be the same. For example, or more first end user devices 102A-N are collectively referred as a first end user device 102A for illustrative purpose.

The first end user device 102A is configured for sending a first registration request to the cloud storage platform 106 for creating a first account with the cloud storage platform 106. A data processing unit (not shown) hosted in the cloud storage platform 106 receives the first registration request from the first end user device 102A, creates the first account for first end user device 102A and provides first user credentials to the first end user device 102A for subsequent authorization. It is to be noted that the data processing unit is a hardware that is optimized for specific tasks such as networking, storage management, and data processing etc.

After registering with the cloud storage platform 106, the first end user device 102A is configured for uploading at least one document to the cloud storage platform 106 for storing the at least one document. It is to be noted that the document is a digital file or a data object that contains structured or unstructured information and is intended for human reading or processing by software applications. In computing, documents can take various formats and serve numerous purposes, from personal use to business operations. The various form of the documents includes, but not limited to, text documents, spreadsheets, presentations, portable document format (pdf), web documents, images and graphics, multimedia, cad files, 3d model files, database files, e-books, compressed and archive files, and logs and configuration files. The first end user device 102A is configured to indicate whether the document is designated for storing in the DLP server 108 or in the non-security storage server 110. In one embodiment, the first end user device 102A designates the document for storing in the DLP server 108. In another embodiment, the first end user device 102A designates the document for storing in the non-security storage server 110. In some embodiments, the at least one document is fingerprinted at the first end user device 102A while creating the at least one document in the first end user device 102A. This initial fingerprinting ensures that the document is immediately tagged for security, enabling seamless tracking and protection against unauthorized access. This setup not only enhances data protection but also ensures that documents are easily retrievable and managed efficiently. In some embodiments, after creation of the document, the document is fingerprinted while storing at a file storage system at a user side interface (i.e., local storage in the first end user device 102A) of the cloud storage platform 106, if the document may not be fingerprinted while creation of the document. In some embodiments, the document is fingerprinted again after fingerprinting while creation of the document. It is to be noted that the fingerprinting is a process of generating a unique digital identifier for a document. This identifier is created by analyzing the document's content, structure, or metadata to produce a distinct signature that can be used to track, authenticate, and monitor the document throughout its lifecycle.

The cloud storage platform 106 is configured for receiving the document uploaded by the first end user device 102A. If the uploaded document is designated for the DLP server 108, the data processing unit of the cloud storage platform 106 moves the document to the DLP server 108. If the uploaded document is not designated for the DLP server 108, the data processing unit of the cloud storage platform 106 moves the document to the non-security storage server 110 where the document is stored in the non-security storage server 110.

The DLP server 108 includes a memory unit 114 configured for storing a first set of instructions and a processor 112 configured for executing the first set of instructions to perform various functions of the DLP server 108. The DLP server 108 is configured for receiving the document uploaded by the first end user device 102A, creating a DLP folder (not shown in FIG .1) for storing the document in the DLP folder, prompting the first end user device 102A to set a sensitivity level of the document, and fingerprinting the document while storing the document in the DLP folder based on the sensitivity level set by a first user using the first end user 102A. In some embodiments, the DLP server 108 is configured to perform granular fingerprinting by fingerprinting each and every segment of the document if the sensitivity level of the document is set as high. In some embodiments, the DLP server 108 is configured to perform less granular fingerprinting by fingerprinting broader segment of the document if the sensitivity level of the document is set as low. For example, when the sensitivity level is 90% or above, the DLP server 108 performs granular fingerprinting by generating a unique digital identifier for each individual cell in a spreadsheet or each line in the document. This detailed approach ensures that highly sensitive content is meticulously tracked and protected. Conversely, when the sensitivity is set as 50% or below, the fingerprinting process is less granular, targeting broader segments such as entire rows or columns in the spreadsheet and entire paragraphs in the document. This allows for a balance between security and performance, applying rigorous protection only where necessary based on the defined sensitivity level. It is to be noted that once the document is stored in the DLP folder, the fingerprinting is immediately is started and policy for protection is pushed to all endpoints to protect the leak. The created fingerprints may be document fingerprint and/or dataset fingerprint. The document fingerprint is the fingerprint created for broader segments of the document. The dataset fingerprint is the fingerprint created for each and every part of the document.

The DLP server 108 is further configured to map the DLP folder to a main folder of a cloud storage account of the first end user device 102A, thereby visible to the first user in the local storage. Accordingly, when the first user views a local file storage in the first end user device, the first user views the DLP folder comprising sensitive document as part of the main folder, even though the sensitive documents are actually stored in the cloud. This integration ensures that sensitive documents are easily accessible while maintaining cloud-based security. Therefore, for end user, it would be easier to identify the designated DLP folder which is dedicated for the sensitive documents, the end user is guided with prompts and tips to efficiently create and manage DLP folders according to their storage allocation, enhancing organization and security.

The DLP server 108 is further configured to provide access to the first user only (i.e., owner of the main folder and the DLP folder) and no one else, including any third-party systems or IT personnel, should have access to the DLP folder. The DLP server 108 continuously monitors access to the DLP folder, tracking all actions performed by the first user and maintains detailed logs to record access events, ensuring that any suspicious activity can be investigated and addressed promptly. In some embodiments, the DLP server 108 is configured to notify the first user of any unusual access attempts or policy violations, providing real-time alerts for potential security threats. The DLP server 108 is further configured to review access permissions and security policies periodically remain effective and aligned with the security requirements. The security policies and configurations are updated periodically as needed to adapt to evolving security threats and user needs.

After creation of the fingerprint, the DLP server 108 is configured to index the fingerprints and store the indexed fingerprints in a fingerprint index table. Indexing is a process of cataloguing the fingerprints, typically in a structured manner, to facilitate quick look up and comparison against incoming data. The fingerprint index table act as a database where each entry corresponds to a specific fingerprint, allowing the DLP server 108 to reference the fingerprints when scanning for sensitive content. In some embodiments, the fingerprints and the fingerprint index table are stored in the DLP server 108 for further process. In some embodiments, the fingerprints and the fingerprint index table are stored in the non-security storage server 110 for further process. The DLP server 108 access the fingerprints and the fingerprint index table stored in the non-security storage server 110 using a data protection agent to validate the fingerprint the moment some information is copied out of the cloud storage platform 106. In a preferred embodiment, the sensitive document and the fingerprint are stored in DLP server 108 of the cloud architecture 106, and their storage modules are tightly integrated for traffic exchange in order to get the responses faster and efficient access. For example, the sensitive document and the fingerprint storage module may be connected via a secure private within tenant API so data never leaves the environment of the storage cloud provider 106 hence don't pose extra risk on the data. The DLP server 108 is configured to update the fingerprint index table in real-time.

The DLP server 108 is configured to share the created fingerprints (i.e., document fingerprint and/or dataset fingerprints) to the first end user device 102A and the one or more second end user devices 118A-N installed with an endpoint security agent 120 like information protection systems (IPS) and mobile device management (MDM). It is to be noted that the one or more second end user devices 118A-N are integrated with the cloud storage platform 106 for data leakage prevention. Thereafter, the endpoint security agent 120 continuously compare local files in the one or more second end user devices 118A-N with the received fingerprints to detect data leakage and notify the DLP server 108. In some embodiments, the endpoint security agent 120 compares local files in the one or more second end user devices 118A-N with fingerprints stored in the DLP server 108 if an event of copying or sharing a document through a security network is triggered. In one instance, the security network is company's security network. For example, there is a board meeting presentation with few very confidential information however whole document is not confidential however the document is classified as sensitive as per meta tag classification. The chief executive officer (CEO) forwards that presentation to his or her executive assistant (EA). The EA tries to copy that confidential information paragraph from the sensitive document and shares via his or her email to a public email address or paste on another document and classifies that as public and sends out. When such event of copying or sharing is occurred, the endpoint security agent 120 triggered to compare the documents which is tried to be copied or shared with fingerprints stored in the DLP server 108. The endpoint security agent 120 detect leak if a match occurs between a local file on a second end user's device and a fingerprint stored in the DLP server 108. After notification, the DLP server 108 is configured to analyze the leaked fingerprint to identify the leaked document and/or leaked dataset if applicable, and leaking endpoint location. The leaked document is detected by matching the leaked fingerprint with stored document fingerprints, thereby the leaked document is detected. If data set fingerprints were generated, the DLP server 108 pinpoints the exact data set within the document that has been leaked. In some embodiments, the DLP server 108 is configured to perform fingerprint matching if an event is occurred on the one or more second end user devices 118A-N.

The DLP server 108 is configured to generate a leak alert comprising leaked document and/or leaked dataset if applicable, and leaking endpoint location and notify the leak alert to the first user end device 102A, thereby enabling the document owner to take informed action like revoking access, investigating the leak, or notifying relevant authorities to address the leak. In some embodiments, an endpoint security agent 120 of the second end user device 1 automatically blocks copying or sharing of the sensitive document if match is found.

In some embodiments, the DLP server 108 is configured to monitor the document (i.e., sensitive document) stored in the DLP folder for a predefined time and move the document to the non-security server 110. Accordingly, the DLP server 108 the fingerprint index table and security endpoint lists based on monitoring status. By monitoring documents for a specific time, the DLP server can ensure that sensitive data remains protected during its most critical period. This allows the organization to enforce temporary access controls based on business needs or regulatory requirements. The monitoring period enables the DLP server to assess the document's activity, track access patterns, and identify potential risks. If suspicious behavior is detected, immediate action can be taken to mitigate the risk. Storing sensitive documents in a high-security environment (DLP folder) requires significant resources. By moving documents to a non-security server after a predefined period, the organization can optimize the use of secure storage resources for active and high-risk documents. Once documents have been monitored and are deemed less sensitive, they can be archived or retained in a less secure environment, aligning with data retention policies. For example, if one file is sensitive before the IPO of a company, the documents can be kept in the DLP folder, however once the IPO is released and information became public and there is no point protecting the same, it can be removed from the DLP folder which will make it available without monitoring, this feature is not available with any DLP providers at the moment especially on the cloud storage.

The system and method of the present disclosure ensures enhanced data security through real-time in-cloud fingerprinting and access control the protection of sensitive content within documents. By employing per-data-set fingerprinting, the system improves data integrity by offering granular detection and protection against information leaks. The secure storage of fingerprints within the same tenant allows for faster leak detection. Dynamic information monitoring provides increased control by enabling temporary protection for sensitive content in classified documents. The system generates highly detailed leak alerts, notifying the document owner about the specific document and data at risk, the location of the leak, and the individual attempting the breach. This approach offers a unique solution for cloud document storage, potentially surpassing current DLP solutions by enabling real-time, granular, and dynamic data protection through precise information fingerprinting.

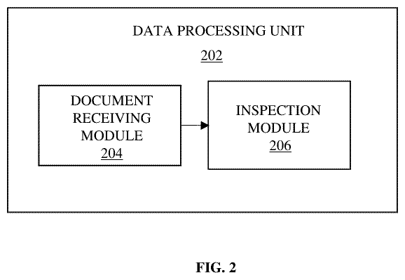

FIG. 2 is a block diagram that illustrates one or more components of a data processing unit 202 of the cloud storage platform 106 of FIG. 1 according to some embodiments herein. The data processing unit 202 includes a document receiving module 204 and an inspection module 206. The document receiving module 204 is configured for receiving the document uploaded by the first end-user device. The inspection module 206 is configured for determining whether the received document is designated for storage in the DLP server 108 or in the non-security storage server 110. If the document is designated for the DLP server 108, the inspection module 206 directs the document to the DLP server 108. If the document is not designated for the DLP server 108, the inspection module 206 directs the document to the non-security storage server 110. In some embodiments, the first user may designate the document for the DLP server 108. In some embodiments, the inspection module 206 automatically identify the sensitive document based on content analysis, fingerprint analysis, metadata examination, and policy evaluation using machine learning models. The content analysis may be performed by scanning the document for specific keywords or phrases that indicate sensitivity, such as “confidential,” “restricted,” or other custom-defined terms related to sensitive content. Alternatively, the content analysis may be performed by identifying data patterns that suggest sensitive content, such as credit card numbers, social security numbers, or other personally identifiable information (PII). Fingerprinting analysis may be performed by matching an existing fingerprint stored in the fingerprint index table whether it is already flagged as sensitive. Metadata examination may be performed by examining metadata associated with the document, such as author, creation date, access permissions, and classification labels. Metadata can provide context about the document's sensitivity and intended use. Alternatively, the metadata examination may be performed by analyzing the classification labels associated with the document indicating sensitivity (e.g., “Top Secret”), it is likely to be designated for storage in the DLP server 108. Policy evaluation may be performed by evaluating the document against predefined security policies that determine storage location based on content, context, and classification. Policies might dictate that certain types of data must always be stored in the DLP server. Alternatively, the business-specific rules may be applied, such as storing financial reports in secure storage during a certain period, like fiscal year-end reporting. In some embodiment, the inspection module 206 employs machine learning models to determine whether the document is sensitive document or not. The machine learning models are trained with large dataset to detect the sensitive document.

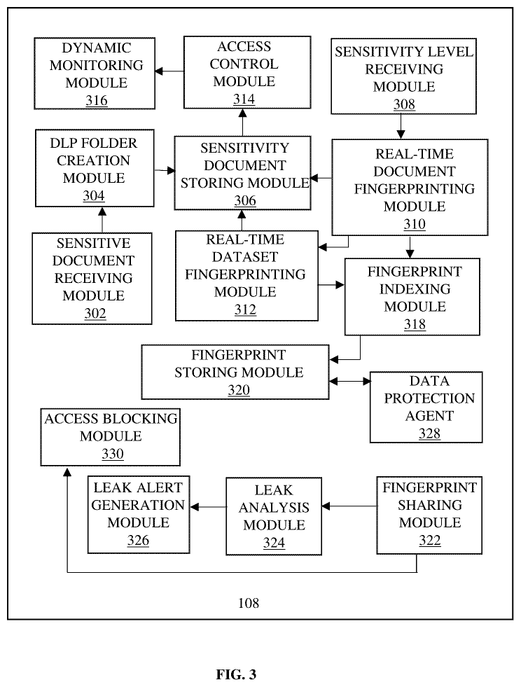

FIG. 3 is a block diagram that illustrates one or more modules of the data leaking protection (DLP) server 108 of FIG. 1 according to some embodiments herein. The DLP server 108 includes a sensitive document receiving module 302, a DLP folder creation module 304, a sensitivity document storing module 306, a sensitivity level receiving module 308, a real-time document fingerprinting module 310, a real-time dataset fingerprinting module 312, an access control module 314, a dynamic monitoring module 316, a fingerprint indexing module 318, a fingerprint storing module 320, a fingerprint sharing module 322, a leak analysis module 324, a leak alert generation module 326, a data protection agent 328, and an access blocking module 330. The sensitive document receiving module 302 is configured for receiving the sensitive document. For example, an employee uploads a confidential financial report to the company's cloud storage. The module detects the upload and receives the document for further handling. The DLP folder creation module 304 is configured for creating the DLP folder for the storing the sensitive document. For example, once the financial report is uploaded, the DLP folder creation module 304 automatically creates a secure folder named “Financial Reports Q3” to store the document. The sensitivity document storing module 306 is configured for storing the sensitive document in the DLP folder. If the first user already has the DLP folder, the sensitive document is directly stored in the exiting DLP folder. The sensitivity level receiving module 308 is configured for prompting the first end user device 102A to set the sensitivity level of the document and receive the sensitivity level of the document from the first end user device 102A. For example, the user is prompted to classify the financial report as “High Sensitivity” due to its confidential nature, and this information is recorded by the module. The real-time document fingerprinting module 310 is configured for performing real-time finger printing of the sensitive document based on the sensitivity level of the document. For example, the text to be fingerprinted is “detecting, by the endpoint security agent 120 of the second end-user devices 118A, leak of the sensitive document if the document and/or data set finger print and local files on the second end user devices are matched”, the real-time document fingerprinting module 310 converts the text to be fingerprinted into fingerprint hash→1122DD. If the sensitivity of the document is low or moderate, the real-time document fingerprinting module 310 performs fingerprinting of broader segments of the documents than on the granular level. For example, for a moderately sensitive project update document, the real-time document fingerprinting module 310 generates fingerprints for larger sections like paragraphs rather than individual lines, if the sensitivity of the document is high, the real-time dataset fingerprinting module 312 is configured for performing fingerprinting of each and every part of the document. For example, the highly sensitive financial report is fingerprinted at a granular level, analyzing each cell of an embedded spreadsheet to ensure security. The access control module 314 is configured for providing access only to the first end user device (i.e., document owner) for accessing the DLP folder upon receiving valid credentials. For example, the document owner logs in with credentials and gains access to the “Financial Reports Q3” folder, while unauthorized attempts are blocked. The dynamic monitoring module 316 is configured for monitoring the sensitive document for the predefined period and move the sensitive document out of the DLP folder. The predefined period is set by the first user. For example, the financial report is actively monitored for six months. After this period, the document is automatically moved to an archival server for long-term storage. The fingerprint indexing module 318 is configured for indexing the created fingerprints (i.e., document fingerprints and/or document dataset fingerprints). For example, the fingerprints of the financial report are indexed with identifiers, such as document ID and creation date, for quick access during security checks. According to the status of the monitoring module, the fingerprint indexing module 318 updates the fingerprint index table. The fingerprint storing module 320 is configured for storing the indexed fingerprint in the fingerprint index table in the DLP server 108 or the non-security storage server 110. For example, the fingerprints of moderately or highly sensitive documents are stored in the DLP server, while others may be stored in a less secure location based on policies. The fingerprint sharing module 322 is configured for sharing the fingerprint (i.e., document fingerprint and/or document dataset fingerprint), to the endpoint security agent 120 installed in the one or more second end user devices 118A-N. For example, the fingerprints of the financial report are distributed to security agents on employees'laptops to prevent unauthorized sharing. According to the status of the monitoring module, the fingerprint sharing module 322 updates the end security point with the fingerprints. The leak analysis module 324 is configured for analyzing the leak once leakage alert is received from the one or more second end user devices 118A-N to detect the leaked document and/or leaked dataset if applicable, and leaking endpoint location. For example, the alert indicates that part of the financial report has been accessed from an unauthorized device. The leak analysis module 324 identifies the endpoint and specific document segments involved in the leak. The leak alert generation module 326 is configured for generating the leak alert comprising the leaked document and/or leaked dataset if applicable, and leaking endpoint location and notify the alert to the first end user device 102A (i.e., document owner). For example, the leak alert is generated showing that an unauthorized attempt to copy data occurred from an external location, specifying the document and the user involved. The document owner is notified immediately. The data protection agent 328 is configured for accessing the fingerprint if the fingerprints are stored outside the DLP server 108. For example, when a document is accessed from a backup location, the agent retrieves its fingerprint from an external server to verify its authenticity and integrity. The access blocking module 330 is configured validate the fingerprint the moment some information is copied out of the DLP server 108. For example, when a user attempts to download the financial report to a USB drive, the access blocking module 330 checks the document's fingerprint against the index. If it detects a mismatch or unauthorized copying, the action is blocked and logged. In some embodiments, the leak analysis module 324 triggers the access blocking module 330 if leak is detected, to block the action of accessing the sensitive document. For example, on a mobile device or a tablet device someone trying to load a sensitive document, so on the cloud endpoint agent or second end-user device endpoint security agent 120 will check the 1122DD (fingerprinted generated) and match to the sensitive document, then the endpoint security agent 120 stops the sharing of the sensitivity document and blocks the sharing of the sensitive document. For example, in an enterprise environment, when an employee attempts to copy, share, or otherwise access a sensitive document, the endpoint security agent integrated with the Data Loss Prevention (DLP) server intervenes. The DLP server 108's security agent or second end user device 118A security agent 118A performs a real-time comparison between the document's unique characteristics—often referred to as its “fingerprint”—and the fingerprints of sensitive documents stored on the DLP server 108. If a match is found, indicating that the document contains protected or confidential information, the agent automatically blocks the action, preventing the user from copying, sharing, or accessing the document. Concurrently, the system logs this event in the DLP server 108, providing a record for future reference and ensuring compliance with data protection policies. This process not only prevents potential data breaches but also aids in auditing and monitoring data usage within the organization. The DLP server 108 also comprises a mapping module (not shown). The mapping module is configured to map the DLP folder to a main folder of a cloud storage account of the first end user device 102A, thereby visible to the first user in the local storage. Accordingly, when the first user views a local file storage in the first end user device 102A, the first user views the DLP folder comprising sensitive document as part of the main folder, even though the sensitive documents are actually stored in the cloud. This integration ensures that sensitive documents are easily accessible while maintaining cloud-based security. Therefore, for end user, it would be easier to identify the designated DLP folder which is dedicated for the sensitive documents, the end user is guided with prompts and tips to efficiently create and manage DLP folders according to their storage allocation, enhancing organization and security.

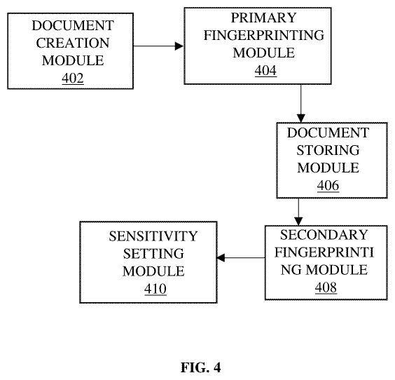

FIG. 4 is a block diagram that illustrates one or more modules of the first end user device 102A of FIG. 1 according to some embodiments herein. The first end user device 102A includes a document creation module 402, a primary fingerprinting module 404, a document storing module 406, a secondary fingerprinting module 408, and a sensitivity setting module 410. The document creation module 402 is configured for creating a document according to the user input. For example, the user opens a word processor on the end device and creates a new document titled “Project Proposal,” typing in details about a new business initiative. The module facilitates the creation of the document and manages text input, formatting, and saving initial drafts. The primary fingerprinting module 404 is configured for fingerprinting the document after creation. For example, as soon as the “Project Proposal” document is created, the primary fingerprinting module 404 creates a digital fingerprint by hashing its contents. This fingerprint is stored alongside the document metadata, allowing for future tracking and verification. The document storing module 406 is configured for the document after fingerprinting in the local storage of the cloud storage platform 106 in order to upload the document to cloud. After the “Project Proposal” document is fingerprinted, it is stored in a designated folder on the user's device, which is linked to the cloud storage platform 106. The document storing module 406 ensures the document is uploaded to the cloud storage platform 106 as part of the user's file synchronization settings. The secondary fingerprinting module 408 is configured for fingerprinting the document while in the local storage. Before the “Project Proposal” document is uploaded to the cloud, the secondary fingerprinting module 408 re-generates a fingerprint, taking into account any additional metadata or changes made since the initial fingerprint. This ensures that any changes are detected and that the document uploaded to the cloud matches the version intended by the user. The sensitivity setting module 410 is configured for setting sensitivity of the document upon receiving prompt from the DLP server 108. The sensitivity level may be set as low, moderate, and high.

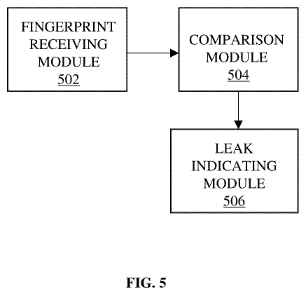

FIG. 5 is a block diagram that illustrates one or more modules of an endpoint security agent 120 of a second end user device 118A of FIG. 1 according to some embodiments herein. The endpoint security agent 120 includes a fingerprint receiving module 502, a comparison module 504, and a leak indicating module 506. The fingerprint receiving module 502 is configured for receiving the fingerprints (i.e., document fingerprint and/or document dataset fingerprint) from the DLP server 108. For example, the DLP server 108 generates fingerprints for sensitive documents stored in the cloud. These fingerprints are sent to the endpoint security agent 120 on a company employee's laptop (one of the one or more second end user devices 118A-N). The fingerprint receiving module collects these fingerprints and prepares them for comparison. The comparison module 506 is configured for comparing local files in the one or more second end user devices 118A-N with the received fingerprints to detect data leakage. For example, an employee downloads several files from the cloud to work offline. The comparison module 504 scans these local files, checking their fingerprints against the ones received from the DLP server 108. If a file on the device matches the fingerprint of a highly sensitive document that shouldn't be locally stored, the comparison module 504 flags this as a potential data leak. The fingerprint index finds the right storage location for the stored and updated fingerprints, thereby matching of the fingerprint easily performed. The leak indicating module 506 is configured for indicating the detected leak to the DLP server 108. For example, upon detecting a file match that indicates unauthorized storage or access, the leak indicating module 506 sends a report to the DLP server 108. This report includes details such as the document name, location on the device, and the user involved. The DLP server 108 can then initiate predefined security protocols, such as alerting the document owner or locking the document to prevent further access.

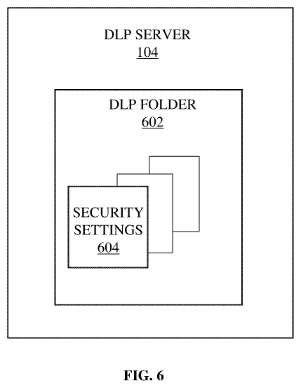

FIG. 6 is a block diagram that illustrates a DLP folder 602 created in the DLP server 108 of FIG. 1 according to some embodiments herein. With reference to FIGS. 1-5, an exemplary DLP folder 602 is created for illustrative purpose which does not limit the scope of the present disclosure. When a sensitive document is identified for storage, the DLP server 108 initiates the creation of a DLP folder 602 specifically for housing the sensitive document. The DLP folder 602 is configured with security settings 604 that align with the organization's data protection policies. These settings may include access controls, encryption standards, and monitoring capabilities to ensure only authorized users can access the contents. The DLP folder 602 serves as a central repository for sensitive documents, allowing the DLP system to apply consistent security measures across all stored files. This includes applying real-time fingerprinting, setting sensitivity levels, and enabling dynamic monitoring for potential data leaks. Only designated users, such as document owners or authorized personnel, are granted access to the DLP folder 602. This is managed through the DLP server's access control module 314, which ensures that credentials are validated before allowing access. The DLP folder 602 is subject to continuous monitoring by the DLP server 108. This includes checking for unauthorized access attempts, changes to document contents, and tracking document movement to prevent data loss or theft.

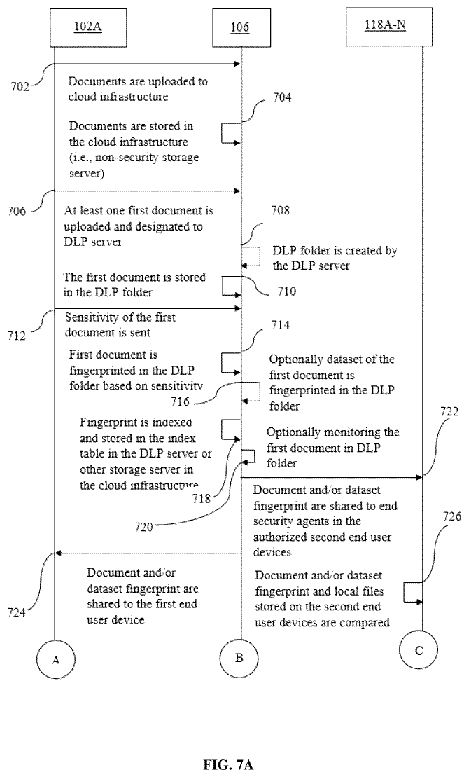

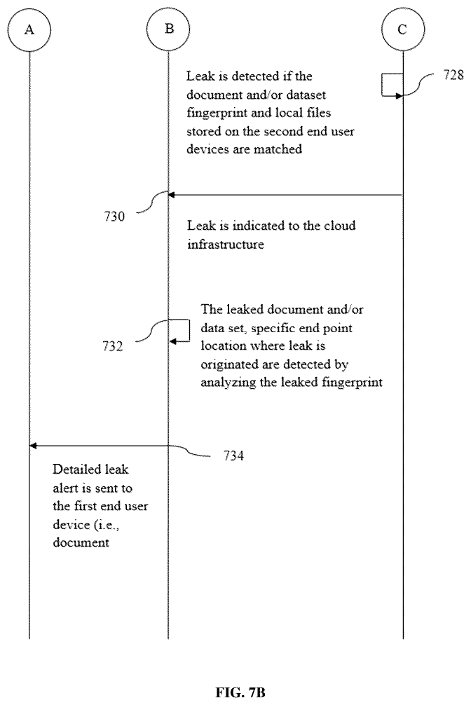

FIGS. 7A-7B are an interaction diagram that illustrate a process of real-finger printing of information in a cloud storage platform 106 for preventing data leakage according to some embodiments herein. At step 702, documents are uploaded, to cloud storage platform 106, using a first end user device 102A. The documents are not designated for a DLP server 108. At step 704, the documents are stored in non-security storage server 110 of the cloud storage platform 106 as the documents are not designated for a DLP server 108. At step 706, at least one first document is uploaded and designated, by the first end user device 102A, to DLP server 108. At step 708, a DLP folder is created in the DLP server 108 for the sensitive document. At step 710, the first document is stored in the DLP folder 602 by the DLP server 108. At step 712, a sensitivity level of the first document is sent by the first end user device 102A. At step 714, the first document is fingerprinted in the DLP folder, based on sensitivity level, by the DLP server 108. At step 716, optionally dataset of the first document is fingerprinted in the DLP folder. At step 718, created fingerprint is indexed and stored in a fingerprint index table in the DLP server 108 or other storage server in the cloud infrastructure 106. At step 720, optionally the first document is monitored in the DLP folder. The DLP server 108 provides only access to the document owner upon receiving authorized credentials. At step 722, document and/or dataset fingerprint are shared to the endpoint security agent 120 in the authorized one or more second end user devices 118A-N. At step 724, the document and/or dataset fingerprint are shared to the first end user device 102A. At step 726, the document and/or dataset fingerprint and local files stored on the second end user devices are compared with local files in the one or more second end user devices 118A-N. In some embodiments, the document and/or dataset fingerprint and local files stored on the second end user devices are compared with local files in the one or more second end user devices 118A-N if an event of copying or storing or sharing or any means of access of document is triggered. The fingerprint index finds the right storage location for the stored and updated fingerprints, thereby matching of the fingerprint easily performed. At step 728, leak is detected by the one or more second end user devices 118A-N if the document and/or dataset fingerprint and local files stored on the one or more second end user devices 118A-N are matched. At step 730, the leak is indicated to the DLP server 108 of the cloud storage platform 106. At step 732, the leaked document and/or data set, specific end point location where leak is originated are detected by the DLP server 108 by analyzing the leaked fingerprint. At step 734, the detailed leak alert is sent to the first end user device 102A (i.e., document owner) by the DLP server 108. At step 736, an endpoint security agent 120 of DLP server 108 blocks an action of copying or sharing or any means of access of sensitive document, if the match occurred between the document to be copied or shared or accessed with fingerprint stored in the DLP server 108 and also logs an event in the DLP server 108. In some embodiments, as shown in step 738, an endpoint security agent 120 of second end user device 118A blocks an action of copying or sharing or any means of access of sensitive document, if the match occurred between the document to be copied or shared or accessed with fingerprint stored in the DLP server 108 and also logs an event in the DLP server 108.

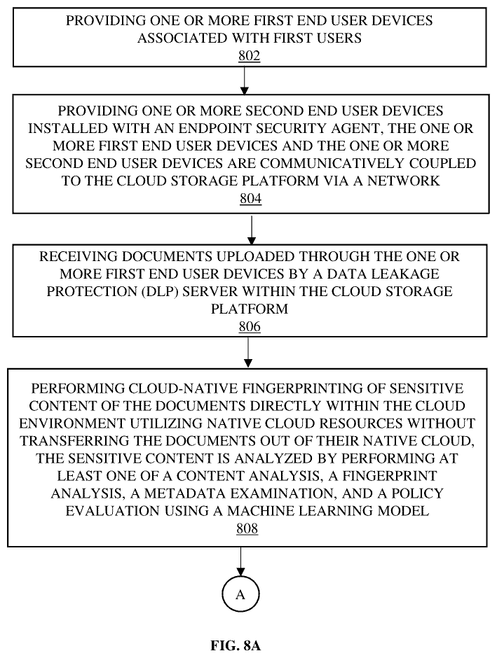

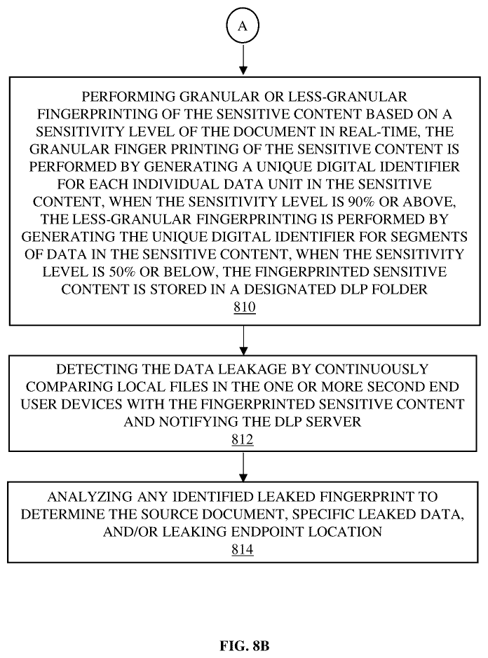

FIGS. 8A-8B are flow diagram that illustrates a method of real-finger printing of information in a cloud storage platform for preventing data leakage according to some embodiments herein.

At step 802, the method includes providing one or more first end user devices associated with first users. At step 804, the method includes providing one or more second end user devices installed with an endpoint security agent, the one or more first end user devices and the one or more second end user devices are communicatively coupled to the cloud storage platform via a network. At step 806, the method includes receiving documents uploaded through the one or more first end user devices by a data leakage protection (DLP) server within the cloud storage platform. At step 808, the method includes performing cloud-native fingerprinting of sensitive content of the documents directly within the cloud environment utilizing native cloud resources without transferring the documents out of their native cloud, the sensitive content is analyzed by performing at least one of a content analysis, a fingerprint analysis, a metadata examination, and a policy evaluation using a machine learning model. At step 810, the method includes performing granular or less-granular fingerprinting of the sensitive content based on a sensitivity level of the document in real-time, the granular finger printing of the sensitive content is performed by generating a unique digital identifier for each individual data unit in the sensitive content, when the sensitivity level is 90% or above, the less-granular fingerprinting is performed by generating the unique digital identifier for segments of data in the sensitive content, when the sensitivity level is 50% or below, the fingerprinted sensitive content is stored in a designated DLP folder. At step 812, the method includes detecting the data leakage by continuously comparing local files in the one or more second end user devices with the fingerprinted sensitive content and notifying the DLP server. At step 814, the method includes analyzing any identified leaked fingerprint to determine the source document, specific leaked data, and/or leaking endpoint location.

For example, a board meeting presentation containing confidential information, where only specific sections (and not the entire document) are classified as sensitive according to meta tag classification. The Chief Executive Officer (CEO) forwards the presentation to an Executive Assistant (EA). If the EA attempts to copy a paragraph containing confidential information from the sensitive document and share it via a public email address, the endpoint security agent 120 on the second end-user device 118A or the DLP server 108 is immediately triggered to perform real-time fingerprint matching. This process identifies whether the document being copied or shared is stored within the DLP folder as a sensitive document.

If a match is detected within the DLP server 108 database, the server blocks the sharing or copying of the sensitive document. The DLP server 108 creates fingerprints of the sensitive document or its dataset, generating an index for each fingerprint. These fingerprints may be created based on individual rows, words, paragraphs, or the entire document, and are stored in the DLP server 108 within the cloud architecture. During any such event, the endpoint security agent 120 of the DLP server 108 or the second end-user device 118A-N is triggered when it detects that a document is being sent outside the company's secure network, whether through email text, email attachment, or any other channel such as a mobile device or phone. The endpoint security agent 120 compares the fingerprint of the document being copied or shared with the central database in the native cloud architecture 106, responding in milliseconds to indicate whether a match exists. If a match is found, the endpoint security agent 120 on the second end-user device 118A or the DLP server 108 initiates a predetermined action, such as blocking the transmission or issuing an alert, depending on the system's configuration.

The system 100 enables to secure data on mobile devices based on finger printing rather than meta tag which can be bypassed in case someone try to copy few part of the data and leak out of organization. In one instance, leakage detection flow includes the following steps: Step 1: Event of information exchange triggered on the device based on Microsoft® office 365 software. Step 2: Information exchange trigger also triggers the fingerprint matching process from the device to the cloud data center where the documents are stored for example O365. Step 3: Fingerprint index finds the right storage location for the stored and updated fingerprints. Step 4: Matching of the fingerprint is performed. Step 5: If there is a match found, the endpoint security agent 120 of the second end user device 118A sends a trigger to the DLP server 108 to take the appropriate action be it a block or an alert to the endpoint device and to the user. Step 5: It also registers the event into the DLP logbook. All the triggers and logs can be stored on the same storage instance of cloud or can be sent out to a Security Information and Event Management (SIEM) tool for forensics.

In some embodiments, GenAI prompts are a big risk for data leak in case some user puts sensitive content sentence on the GenAI prompt as there is no way to detect if that information is confidential or not. It is to be noted that GenAI prompts are the inputs or instructions given to a generative AI model to guide it in producing a desired output. As existing classification either works on the meta tag or based on dictionary matching/Pattern matching, there is no finger print based detection and blocking possible for AI prompt because there is no provisioning of native fingerprint on cloud storage. However, the present disclosure provides defense in depth based on the data finger printing, in this case if there is a detection on the set of information of a specific data towards AI interface as prompt, the present disclosure will not only alert the user/administrator/data owner but also will be able to hold or block the information leakage to the OpenAI cloud, which if happens cannot be reverted because those clouds are public clouds.

In time-sensitive data protection, certain information needs to remain confidential. Managing the confidentiality often goes beyond simply classifying documents based on metadata tags. This creates significant challenges in daily operations. Specific sections or parts of a document may require protection, while other parts can be shared. Current systems often do not provide the granularity needed to handle such cases effectively. Users frequently require IT support to identify and “fingerprint” sensitive portions of a document and configure appropriate protection. When the information becomes public or needs to be shared, IT staff must reconfigure the settings to allow document exchange, leading to additional delays. The system provides a solution by creating predefined set of configurations based on folders for the users to initiate protection right at the point when document is saved in the “DLP” folder. When the document needs to be converted public or non-sensitive, the user just need to remove the document from the specific folder without requiring IT technical team for assistance and operations.

On mobile devices such as phones and tablets, it is not possible to block data leaks based on content, which can lead to serious damage for organizations that allow mobile devices to access company data. In the above case, the system can be deployed directly on the native cloud which can check the data access based on the content fingerprint and block the downloads or copy based on specific content fingerprint rather depending on the meta tag of the entire document, which a is limitation of Microsoft Azure information protection). Hence the DLP solution can be deployed centrally to entire organization beyond the limitation of device type or local operating system.

The embodiments herein may include a computer program product configured to include a pre-configured set of instructions, which when performed, can result in actions as stated in conjunction with the methods described above. In an example, the pre-configured set of instructions can be stored on a tangible non-transitory computer-readable medium or a program storage device. In an example, the tangible non-transitory computer readable medium can be configured to include the set of instructions, which when performed by a device, can cause the device to perform acts similar to the ones described here. Embodiments herein may also include tangible and/or non-transitory computer-readable storage media for carrying or having computer executable instructions or data structures stored thereon.

In the future, as information is accessed through various types of devices such as smart glasses, smart screens, smart robots, and IoT devices, it will become increasingly difficult for data leakage protection to function based on the device's operating system. Additionally, deploying DLP agents on all these devices will not be feasible. The system provides a native cloud-based solution that works on the information blocks-based fingerprinting rather than document meta tags. The system does not require a local agent on the device in case of cloud-based deployment. The system checks the access of the information on the cloud and perform blocking based on the fingerprint of information before the information is released from the cloud to local device, hence the solution can go beyond the local device level limitations and can work on any device from central cloud location.

Generally, program modules utilized herein include routines, programs, components, data structures, objects, and the functions inherent in the design of special-purpose processors, etc. that perform particular tasks or implement particular abstract data types. Computer executable instructions, associated data structures, and program modules represent examples of the program code means for executing steps of the methods disclosed herein. The particular sequence of such executable instructions or associated data structures represents examples of corresponding acts for implementing the functions described in such steps.

The embodiments herein can include both hardware and software elements. The embodiments that are implemented in software include but are not limited to, firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

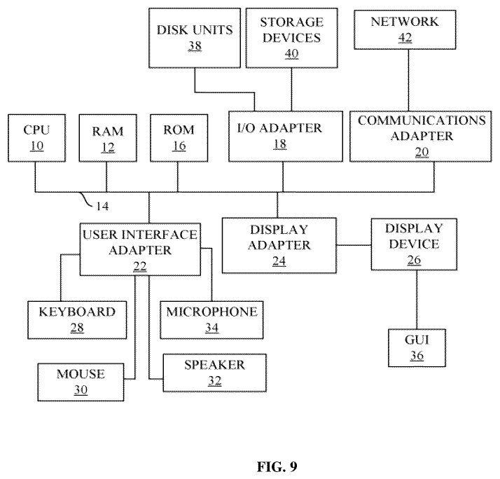

FIG. 9 is a schematic diagram of a computer architecture in accordance with the embodiments herein. A representative hardware environment for practicing the embodiments herein is depicted in FIG. 9, with reference to FIGS. 1 through 8B. This schematic drawing illustrates a hardware configuration of a server/computer system/computing device in accordance with the embodiments herein. The system 900 includes at least one processing device CPU 10 that may be interconnected via system bus 14 to various devices such as a random-access memory (RAM) 12, read-only memory (ROM) 16, and an input/output (I/O) adapter 18. The I/O adapter 18 can connect to peripheral devices, such as disk units 38 and program storage devices 40 that are readable by the system. The system can read the inventive instructions on the program storage devices 40 and follow these instructions to execute the methodology of the embodiments herein. The system further includes a user interface adapter 22 that connects a keyboard 28, mouse 30, speaker 32, microphone 34, and/or other user interface devices such as a touch screen device (not shown) to the bus 14 to gather user input. Additionally, a communication adapter 20 connects the bus 14 to a data processing network 42, and a display adapter 24 connects the bus 14 to a display device 26, which provides a graphical user interface (GUI) 36 of the output data in accordance with the embodiments herein, or which may be embodied as an output device such as a monitor, printer, or transmitter, for example.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the present disclosure.

What is claimed is:

1. A system for performing real-time cloud-native fingerprinting and managing sensitive content within a cloud storage platform to prevent data leakage, wherein the system comprises,
one or more first end user devices associated with first users, and;
one or more second end user devices installed with an endpoint security agent, wherein the one or more first end user devices and the one or more second end user devices are communicatively coupled to the cloud storage platform via a network;
a data leakage protection (DLP) server within the cloud storage platform comprising a memory unit for storing a first set of instructions and a processor configured to execute the first set of instructions to perform various functions of the DLP server comprising,
receiving documents uploaded through the one or more first end user devices;
performing cloud-native fingerprinting of sensitive content of the documents directly within the cloud environment utilizing native cloud resources without transferring the documents out of their native cloud, wherein the sensitive content is analyzed by performing at least one of a content analysis, a fingerprint analysis, a metadata examination, and a policy evaluation using a machine learning model;
performing granular or less-granular fingerprinting of the sensitive content based on a sensitivity level of the document in real-time, wherein the granular finger printing of the sensitive content is performed by generating a unique digital identifier for each individual data unit in the sensitive content, when the sensitivity level is 90% or above, wherein the less-granular fingerprinting is performed by generating the unique digital identifier for segments of data in the sensitive content, when the sensitivity level is 50% or below, wherein the fingerprinted sensitive content is stored in a designated DLP folder;
detecting the data leakage by continuously comparing local files in the one or more second end user devices with the fingerprinted sensitive content and notifying the DLP server; and
analyzing any identified leaked fingerprint to determine the source document, specific leaked data, and/or leaking endpoint location.

2. The system of claim 1, wherein the machine learning model is configured to perform (i) the content analysis using predefined keywords, phrases, or patterns indicative of the sensitive content, (ii) the fingerprint analysis by comparing the document's fingerprint with previously stored fingerprints in a fingerprint index table, wherein the fingerprint index table comprises indices and catalogs of the created fingerprints, (iii) the metadata examination by analyzing the metadata associated with the document, comprising author, creation date, access permissions, and classification labels, and (iv) the policy evaluation by comparing the document's content and metadata against predefined security policies comprising storage location and protection requirements based on document classification and sensitivity.

3. The system of claim 1, wherein the DLP server is further configured to (i) prompt the one or more first end user devices to set a sensitivity level for the document and (ii) receive the sensitivity level from the one or more first end user devices.

4. The system of claim 1, wherein the DLP server is further configured to automatically block copying or sharing of the sensitive document if a match is found during the comparison of local files on the one or more second end user devices with the received fingerprinted sensitive content.

5. The system of claim 1, wherein the DLP server is further configured to map the DLP folder to a main folder of the first end user device's cloud storage account.

6. The system of claim 1, wherein the DLP server is further configured to (i) monitor the sensitive content of the documents for a predefined time, after which the document is moved to a non-security storage server, and (ii) update the fingerprint index table and security endpoint lists.

7. The system of claim 1, wherein the DLP server is further configured to continuously monitor access to the DLP folder, log access events, and notify the first user of any unusual access attempts or policy violations in real-time.

8. The system of claim 1, wherein the DLP server is further configured to create an account on the cloud storage platform for the first users by receiving a registration request from the one or more first end user devices, enabling the uploading of the documents.

9. A method for performing real-time cloud-native fingerprinting and managing sensitive content within a cloud storage platform to prevent data leakage, wherein the method comprises,
providing one or more first end user devices associated with first users;
providing one or more second end user devices installed with an endpoint security agent, wherein the one or more first end user devices and the one or more second end user devices are communicatively coupled to the cloud storage platform via a network;
receiving documents uploaded through the one or more first end user devices by a data leakage protection (DLP) server within the cloud storage platform;
performing cloud-native fingerprinting of sensitive content of the documents directly within the cloud environment utilizing native cloud resources without transferring the documents out of their native cloud, wherein the sensitive content is analyzed by performing at least one of a content analysis, a fingerprint analysis, a metadata examination, and a policy evaluation using a machine learning model;
performing granular or less-granular fingerprinting of the sensitive content based on a sensitivity level of the document in real-time, wherein the granular finger printing of the sensitive content is performed by generating a unique digital identifier for each individual data unit in the sensitive content, when the sensitivity level is 90% or above, wherein the less-granular fingerprinting is performed by generating the unique digital identifier for segments of data in the sensitive content, when the sensitivity level is 50% or below, wherein the fingerprinted sensitive content is stored in a designated DLP folder;
detecting the data leakage by continuously comparing local files in the one or more second end user devices with the fingerprinted sensitive content and notifying the DLP server; and
analyzing any identified leaked fingerprint to determine the source document, specific leaked data, and/or leaking endpoint location.

10. The method of claim 9, wherein the machine learning model is configured to perform (i) the content analysis using predefined keywords, phrases, or patterns indicative of the sensitive content, (ii) the fingerprint analysis by comparing the document's fingerprint with previously stored fingerprints in a fingerprint index table, wherein the fingerprint index table comprises indices and catalogs of the created fingerprints, (iii) the metadata examination by analyzing the metadata associated with the document, comprising author, creation date, access permissions, and classification labels, and (iv) the policy evaluation by comparing the document's content and metadata against predefined security policies comprising storage location and protection requirements based on document classification and sensitivity.

11. The method of claim 9, wherein the method further comprises (i) prompting the one or more first end user devices to set a sensitivity level for the document and (ii) receiving the sensitivity level from the one or more first end user devices.

12. The method of claim 9, wherein the method further comprises automatically block copying or sharing of the sensitive document if a match is found during the comparison of local files on the one or more second end user devices with the received fingerprinted sensitive content.

13. The method of claim 9, wherein the method further comprises mapping the DLP folder to a main folder of the first end user device's cloud storage account.

14. The method of claim 9, wherein the method further comprises (i) monitoring the sensitive content of the documents for a predefined time, after which the document is moved to a non-security storage server, and (ii) updating the fingerprint index table and security endpoint lists.

15. The method of claim 9, wherein the method further comprises continuously monitoring access to the DLP folder, log access events, and notify the first user of any unusual access attempts or policy violations in real-time.

16. The method of claim 9, wherein the method further comprises creating an account on the cloud storage platform for the first users by receiving a registration request from the one or more first end user devices, enabling the uploading of documents.

17. One or more non-transitory computer readable storage mediums storing instructions, which when executed by a processor, causes to perform a method for performing real-time cloud-native fingerprinting and managing sensitive content within a cloud storage platform to prevent data leakage, the method performs the steps of:
providing one or more first end user devices associated with first users;
providing one or more second end user devices installed with an endpoint security agent, wherein the one or more first end user devices and the one or more second end user devices are communicatively coupled to the cloud storage platform via a network;
receiving documents uploaded through the one or more first end user devices by a data leakage protection (DLP) server within the cloud storage platform;
performing cloud-native fingerprinting of sensitive content of the documents directly within the cloud environment utilizing native cloud resources without transferring the documents out of their native cloud, wherein the sensitive content is analyzed by performing at least one of a content analysis, a fingerprint analysis, a metadata examination, and a policy evaluation using a machine learning model;
performing granular or less-granular fingerprinting of the sensitive content based on a sensitivity level of the document in real-time, wherein the granular finger printing of the sensitive content is performed by generating a unique digital identifier for each individual data unit in the sensitive content, when the sensitivity level is 90% or above, wherein the less-granular fingerprinting is performed by generating the unique digital identifier for segments of data in the sensitive content, when the sensitivity level is 50% or below, wherein the fingerprinted sensitive content is stored in a designated DLP folder;
detecting the data leakage by continuously comparing local files in the one or more second end user devices with the fingerprinted sensitive content and notifying the DLP server; and
analyzing any identified leaked fingerprint to determine the source document, specific leaked data, and/or leaking endpoint location.
